(19) United States
(12) Patent Application Publication
(10) Pub. No.: US 2007/0203877 A1
(43) Pub. Date: Aug. 30, 2007

(54) Intermediate cache utility for file system access

(76) Inventors: Fujie Qu, Vernon Hills, IL (US); Jaganmohan R. Gottimukkula, Schaumburg, IL (US); David A. Randolph, Libertyville, IL (US)

Correspondence Address: MOTOROLA INC, 600 NORTH US HIGHWAY 45, ROOM AS437, LIBERTYVILLE, IL, 60048-5343, US

(21) Appl. No.: 11/363,752

(22) Filed: Feb. 28, 2006

(51) Int. Cl. G06F 17/30

(52) U.S. Cl. 707/1

(57) ABSTRACT

Disclosed are methods and systems in software applications for maintaining a list (or lists) of failed open attempts. A software application can attempt to open a file by searching for the file in at least one file system. If there is a failed open attempt, the pathname used for the futile search can be stored in a cache. In this manner, prior to attempting to search for and open a file that previously resulted in a futile search, the software application can check the cache to determine if there were any previous failed open attempts. If a failed open attempt is listed in the cache, the software application can abort the search since the search could otherwise be futile as well.

### FIELD

The present technology relates to file system access for software applications, and more particularly to an intermediate cache utility to track failed attempts to open a file.

### BACKGROUND

Presently, many software applications can include instructions to search file systems for particular files not specified by absolute paths. A popular and straightforward approach to searching is to define a list of directories to search in order. A software application such as a compiler, for example, may perform tens of thousands of searches per compile.

Certain time and resource saving improvements have been made to software applications to reduce the number of file system searches required when running a particular application. For example, certain processes include saving, in a cache, a path to a location where a particular file has been successfully found during a run of the application. While helpful during a particular run of the application, the path information may be lost when restarting the application. Moreover, concurrent instantiations of the application may not benefit from information collected by other instantiations.

In other applications, when a file has been successfully found, its entire contents may be cached. Many compilers, for example, rely exclusively on a file system cache to accelerate file opens during execution. A cache of this type does not alleviate the situation of failed open system calls. The previously described approach may only speed up file retrieval when the requested file actually exists, has been opened previously, and still exists in the cache.

### SUMMARY

Disclosed are methods and systems in software applications for maintaining a list or lists of failed open attempts. A software application can attempt to open a file by searching for the file in at least one file system. If there is a failed open attempt, the pathname used for the futile search can be stored in a cache. In this manner, prior to attempting to search for and open a file that previously resulted in a futile search, the software application can check the cache to determine if there were any previous failed open attempts. If a failed open attempt is listed in the cache, the software application can abort the search since the search could otherwise be futile as well. Also disclosed are optimizations methods to avoid the repeated overhead of opening a file through a virtual file systems by caching direct-access paths to content in the native file system.

### BRIEF DESCRIPTION OF THE DRAWINGS

FIG. 1 is a diagram of an embodiment of the disclosed intermediate cache and its relationships with a make (or build tool) wrapper, a compiler, and a file system;

FIG. 2 is a flow chart of an embodiment of the method including cache interactions; and

FIG. 3 shows an embodiment of the disclosed intermediate cache utility where a parallel build process can be on a single system.

### DETAILED DESCRIPTION

Disclosed are methods and systems that may reduce the time needed to locate files for a software application, such as a compiler performing a software build. A build can be distinguished from compilation. That is, a build can include for example, zero or more compilations, zero or more assembler runs, zero or more archiving runs and zero or more linker runs. An invocation command for a software application can include a list of one or more “include paths” or “search paths” to specify a pathname or location in which to search for a file. Alternatively, or in addition, a shell variable or environment variable can specify this information. The processing of the PATH and CDPATH variables by the various UNIX shells are examples of this approach. In one embodiment, the INCPATH and LIBPATH settings may be employed in many “makefiles.” In the discussion below, any software application is referred to as a compiler. It is understood that any software application, including a compiler, is within the scope of this discussion.

When the compiler is invoked, it can inherit the list of include paths and/or search paths from the software environment in which it was invoked. When there is a failure of an attempt to open a file in one of, or more than one of, a specified plurality of pathnames, the failure or futility of the open attempt is recorded in a cache. That is, the cache tracks failed open attempts. Accordingly, before or simultaneously with attempting to open a file in a given directory, the cache can be queried to see if a failure of an attempt to open a file through the specified pathname is listed. Based on the listed failure, the result of the cache query can indicate that the current attempt to open the file is futile. Therefore, a second open attempt for that path name may be avoided. The time and processing for a cache query to discover a futile entry may be less than that for a second unsuccessful file system open attempt. If the ratio of failed opens to successful opens is high, the performance impact on the build system may be significant.

Before describing in detail embodiments that are in accordance with the present disclosure, it should be observed that the embodiments reside primarily in combinations of method steps and components related to an intermediate cache utility to track failed attempts to open a file. Accordingly, the components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the disclosure described herein may be comprised of one or more conventional processors and unique stored program instructions that control the one or more processors to implement, in conjunction with certain non-processor circuits, some, most, or all of the functions of an intermediate cache utility to track failed attempts to open a file as described herein.

The non-processor circuits may include, but are not limited to, a radio receiver, a radio transmitter, signal drivers, clock circuits, power source circuits, and user input devices. As such, these functions may be interpreted as steps of a method relating to an intermediate cache utility to track failed attempts to open a file. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

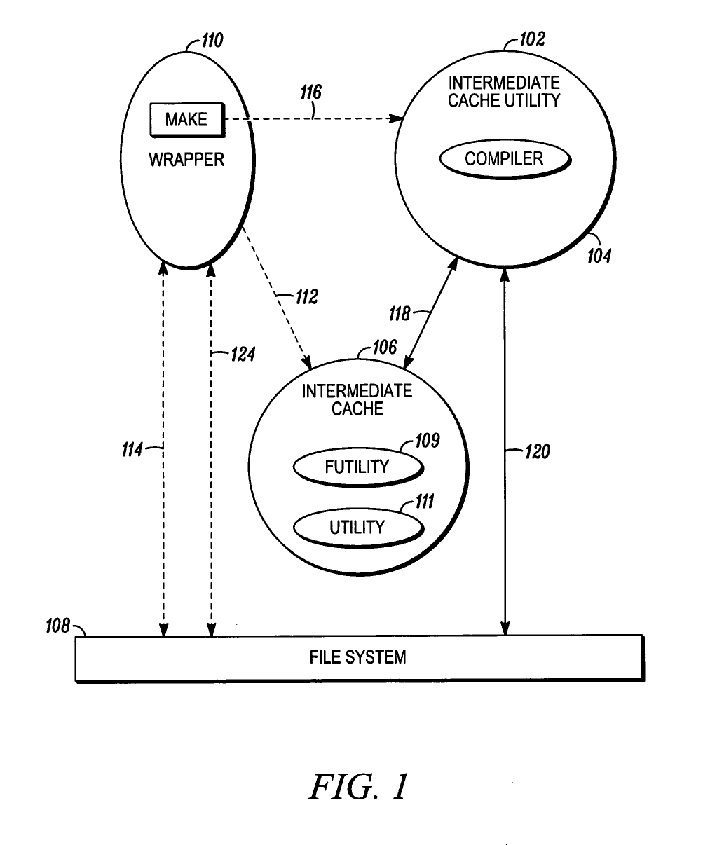

FIG. 1 is a diagram of an embodiment of an intermediate cache utility and an intermediate cache. The drawing shows an intermediate cache utility 102, within which is shown a compiler 104. Also shown are an intermediate cache 106 for maintaining the above-described failed open attempt lists and a file system 108 through which a search is performed based on a specified search path. Two sub-caches are shown within the intermediate cache. A futility cache 109 is shown as is a successful search result cache or utility cache 111, both of which will be discussed in more detail below.

The intermediate cache utility 102 is depicted surrounding the compiler process 104 to illustrate that an intermediate cache utility can mediate interactions between a compiler and a file system 108. The compiler process 104 is shown as an example of a compiler that may access the file system 108. That is, a compiler in accordance with this discussion performs search-path searching of a file system 108. For example, a compiler can locate files associated with non-absolute pathnames by searching through a specified ordered plurality of pathnames.

In a first step 112, the make wrapper may set up the intermediate cache to be used by compiler processes for the build on this system. The user may specify a suitable “knowledge base” file to use 114 to initialize the intermediate cache. If the build is being distributed across multiple systems, step 112 can be performed on each build node. The make utility (or a similar utility) can be configured (or wrappered) in such a way that the compiler may not be called directly, but instead the intermediate cache utility can be invoked 116. Accordingly, the intermediate cache utility described herein may be able to mediate some or all interactions between the compiler and the underlying file system. When a command is made to open an include file, the intermediate cache utility can intercept the system call and can query the intermediate cache 118 to see if the file does not exist on the underlying file system. If the intermediate cache indicates that the file does not exist, the build can be spared the overhead of querying the file system. If the intermediate cache does not know about the existence of the file at the specified path, it can query 120 the file system 108. If the file is found, its contents can be retrieved 120 for use by the compiler 104. The information relating to the found file can also be recorded in the intermediate cache without necessarily caching the contents in the utility subcache 111. If the path does not exist on the file system, the miss can be recorded in the futility subcache 109 of the intermediate cache for future reference.

After the build completes, the make wrapper (if requested) can store the intermediate cache contents in a specified knowledge base file 124 for use in a subsequent build or for other (e.g. informational) purposes. The knowledge base file can contain a complete record of both the source files that contributed to the build and the futility data.

Also, a compiler in accordance with this discussion may be executed on a host computer system in the form of two or more instantiations. That is, several processes invoked under the same program name may share the host computer system's processor(s). For example, in the case of a software build, there may be several instantiations of the compiler running on the same host computer. Each instantiation may perform a compilation of a different source code file. A shared “intermediate” cache can be provided on some or each build host. It may be referred to as “intermediate” because it can be positioned between the local cache that may store similar information with the narrow scope of a single compilation and any general-purpose file system cache that is provided by the operating system (or virtual file system).

As mentioned above, a compiler is an example of a software application. A compiler is a program that translates a set of human-readable source files, written in a “high-level” programming language, or source code, into an intermediate “assembly language,” or object code, which may be subsequently translated by an “assembler” program into a purely binary “machine language” suitable for execution on a digital device. However, even though a compiler, traditional and non-traditional, may be mentioned throughout this discussion as an exemplary software application, it is understood that any and all software applications that access files via search-path searching are included in this discussion.

Since the intermediate cache utility 102 can mediate interactions between the compiler 104 and the file system 108 (that is, by intercepting the search requests made by the compiler 104), it can operate independently from the compiler or other application to be invoked. The compiler 104 may need little or no modification for the operation of the intermediate cache utility 102 and may operate as it would without the intermediate cache utility 102. Essentially, the compiler 104 may have no knowledge of the intermediate cache utility.

In general, the intermediate cache 106 can occupy a segment of shared memory used by a plurality of concurrent compiler processes, such as instantiations, associated with a build or a sequence of builds on a given system. In this manner, the disclosed methods and systems can take advantage of shared memory, as discussed further below. To initialize the intermediate cache, a build utility or a “make” wrapper may be used by the compiler for the particular build on that particular system.

Some software build environments support “distributed builds.” A distributed build takes place when more than one host system participates in the compilation of source code files to produce an executable binary. In the case of distributed builds, a local intermediate cache may be created on each host system of the distributed build, as discussed in further detail below. Semaphores may be used to control access to the shared memory.

In addition, a user may specify a suitable “knowledge base” file to use to initialize the intermediate cache. The knowledge base file may include previously cached information on file system status, including futility and utility data. The knowledge base file may also include additional information useful for the particular compiler accessing the file system.

Semaphores, or some other mechanism that can be provided by an operating system, may be used to mediate read and read/write activity to one or more intermediate caches. A semaphore is a hardware or software flag. In multitasking systems, a semaphore is a variable with a value that indicates the status of a common resource. It is used to lock the resource that is being used. A process needing the resource checks the semaphore to determine the resource's status and then decides how to proceed, including waiting in a queue until the resource becomes available. Concurrent write access to the shared memory can be controlled by use of a semaphore or a similar mechanism provided by the operating system.

Pathnames can be used for searching the file system and the term pathname is used herein in a generic sense. A pathname can be defined in a number of ways. A pathname can be defined to be a character string which can be input to a file system by a user to identify a file. A pathname may normally contain device and/or directory names, and file name specification. A pathname can indicate the location of a particular file or directory by outlining the route or “path” from the host name if the file resides on a remote server through the directory structure to the desired filename or directory name. Each name in the series of names that define a path can be separated by a slash, a backslash, or other symbol, depending on the operating system of the computer.

Were a file system to include files that include header files, for example, the compiler may search header files to locate the subject file. A header file, especially in the context of software building, is a text file containing small bits of program code which may be used to describe the contents of the main body of code to other modules and may use a “.h” extension. In large software projects, header files may include other header files, which may in turn include others. To allow for flexibility in the structure of the source code tree, include statements in source code files may rarely specify absolute paths where the header files may be located. Instead, ordered lists of directories can be specified, which can be searched each in turn for files specified typically by relative path. It is understood that disclosed herein is any method in which the files of a file system can be identified and/or can be searched. Any such method may be considered an open attempt in accordance with this discussion.

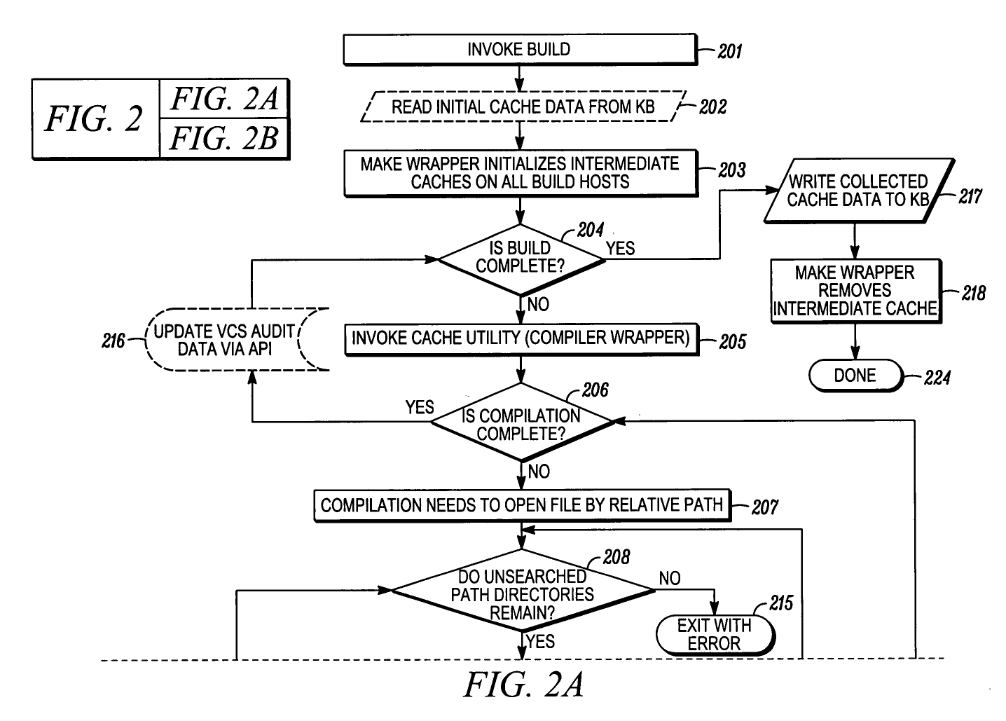

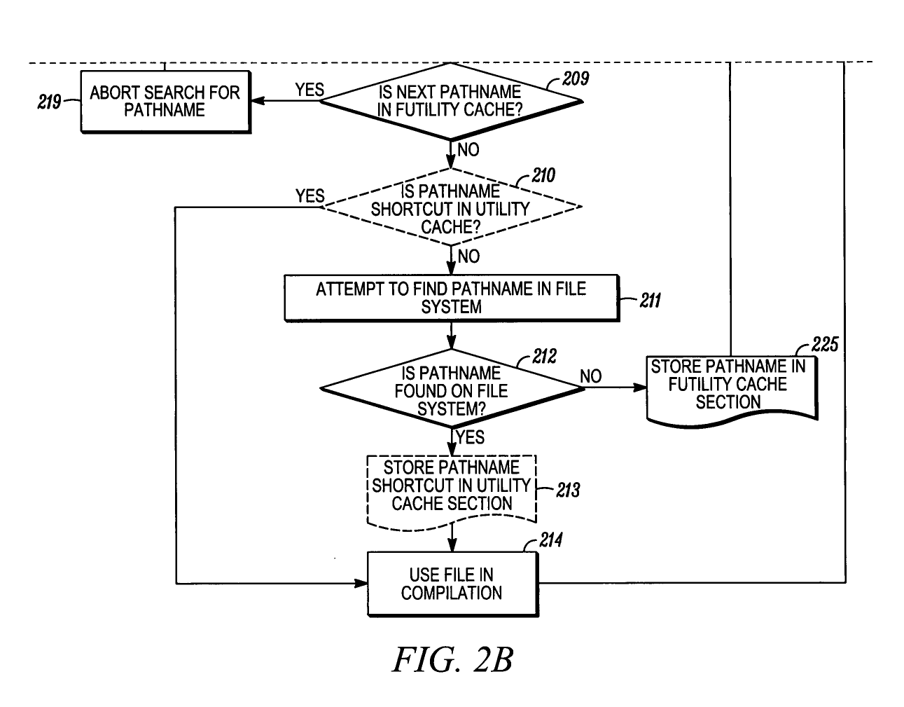

FIG. 2 is a flow chart of the steps of an embodiment of the intermediate cache utility 102, file system 108 and the intermediate cache 106 interactions. Prior to a discussion of the flowchart from its beginning where the method can include a step of invoking a build 201, various portions of the method will be discussed to highlight them. One compilation process may benefit from the futility and/or utility information captured by other compilation processes, either in the current build or in a previous build in a sequence of builds.

In a software application for processing files, an embodiment of the method, as discussed above, can include attempting to open a file—that is, attempting to find a pathname in a file system 211. The embodiment of the method further can include searching for the file in a specified plurality of pathnames in a file system. In searching for the file in a specified plurality of pathnames in a file system, a query may be made as to whether a pathname is found on the file system 212. A search of the file system and the manner in which the files are identified in the file system may be implemented as prescribed by the particular compiler. The embodiment of the method therefore can include storing the pathname of a failed open attempt in a cache when the file is not found in a given pathname of the plurality of pathnames. That is to say, if a pathname is not found on the file system, the pathname may be stored in a futility cache section 225.

Additionally, an embodiment of the method can include storing the pathname of a successful open attempt in the utility cache 111 when the file is found in a second pathname of the plurality of pathnames, that is, if the pathname is found, a step of the method can include storing a pathname shortcut in a utility cache section 213. Recording successful open attempts as well as futile searches can provide time saving information. It may not be necessary to cache the contents of the file in the intermediate cache or any other cache, since historically more processor time is used in futilely searching for files than finding existing files. The intermediate cache 106 can list futile searches and if desired, it can list successful searches. That is, the intermediate cache 106 can track the pathnames of files that a software process attempted to open and failed to open. The intermediate cache 106 can also track the pathnames of files that the software process attempted to open and succeeded in opening. In this way, the compiler 104, for example, may avoid spending time more than once on a futile search. If no knowledge base has been used to initialize the caches, the intermediate caching utility may provide that at most one failed open will occur on each build host. Use of a knowledge base or a mechanism for synchronizing the distributed caches may reduce the failed open calls even further.

In this way, the intermediate cache 106 can capture failed open attempts in futility cache 109 and, if desired, successful open attempts in utility cache 111. The intermediate cache 106 can capture the absolute paths of contributing source files, such as all files opened, for the build. It is understood that the content of the intermediate cache 106 may include different types of information that can avoid a search or open attempt when the same search or open attempt previously made was futile. Moreover, additional information may be cached as well, some of which is discussed below.

A futility entry in the intermediate cache 106 may be removed in the event that a file is created during a build for subsequent access. Also, by monitoring file creation system calls issued by the compiler 104 a utility can determine if a file pathname should be removed from the intermediate cache 106. Other situations may provide that an intermediate cache entry be removed or altered.

Before a search of the file system 211, an embodiment of the method can include, when attempting to open a file, first querying the cache to determine if the pathname of a failed open attempt is stored in the cache. That is, a query can be made as to whether the next pathname sought may be in the futility cache 209. When the compiler 104 has instructions to use a system call to access and/or open, for example, an “include file,” the intermediate cache utility 102 may intercept the system call and query the intermediate cache 106 to see if a search of the file has been made and/or whether the search was futile.

A query 209 as to whether the intermediate cache 106 or the futility cache 109 lists a pathname as non-existent may result in an affirmative or negative answer. If the answer to the query 209 is yes, the assumption then may be made that the file does not exist in the given pathnames or file system. A positive answer may indicate that the compiler has searched for the file, but has not found the file. The failed search can represent a “missing” pathname and/or that the file is non-existent. In that case, a second search for the file may be averted 219 without incurring the expense of the file open/fopen system call. That is, a specific pathname may be ignored when searching for the file when it has been determined that a failed open attempt in the specific pathname has occurred.

If the answer to the query 209 is negative, it may be because it is the first time the compiler has searched for the file and the futility of the search may not be known. In such a situation, the file system 108 can be queried in the search for the file 211. After the search for the file, a query can be made as to whether there has been a successful open attempt 212 during the search. If no open attempt for the file was successful in the course of the search, the futile search path may be recorded 225 in the intermediate cache 106 for future reference.

Accordingly, the embodiment can further include not searching for the failed pathname when it has been determined that the pathname of the failed open attempt is stored in the futility cache 109 as a failed open attempt. In another embodiment, the specific pathname may be ignored when searching for the file in response to determining a failed open attempt in the specific pathname has occurred. That is to say, if the answer to the query 209 is yes, the search for the pathname may be aborted 219 or the pathname ignored. The cache can be positioned to be shared by multiple concurrent or sequential runs of the application.

In general, the intermediate cache 106 can mediate all interactions between the software application and the file system. A make wrapper may initialize an intermediate cache on one or more build hosts 203. A compiler wrapper may invoke a cache utility 205. When there are multiple instantiations of a software application such as a make application or a compiler, the embodiment of the method may include attempting by multiple instantiations of the software application to open a plurality of files and mediating interactions by the cache between the multiple instantiations of the software application and the file system. A final step in the process may be removal of the intermediate cache by the make wrapper 218.

Turning now to a discussion of the flowchart from its beginning step, a build may be invoked 201. Invocation of the build may include use of a “make” wrapper. The “make” wrapper 110 first may be invoked when the build is invoked. Initial cache data may be read from a knowledge base (KB) 202. As previously discussed, the make wrapper may initialize intermediate caches on one or more build hosts 203. Initialization data from the knowledge base may be used in this step. A query may be made whether the build is complete 204. If the build is not complete, the cache utility may be invoked by a compiler wrapper 205.

A query may be made whether the compilation is complete 206. If the compilation is not complete, the compilation may seek to open a file by relative path 207. A query may be made 208 as to whether unsearched path directories remain 208. If unsearched path directories remain, a query may be made as to whether the next pathname sought in the compilation process is entered in the futility cache 209. If the answer to the query is no, then a query may be made as to whether a pathname shortcut is in the utility cache 210. If a pathname shortcut for the pathname is not in the utility cache, an attempt may be made to find the pathname in the file system 211. Pathname shortcuts are tracked via a “utility” subcache section of the intermediate cache, to be discussed below.

A query may be made as to whether the pathname is found on the file system 212. If the pathname is found, then a pathname shortcut may be stored in a “utility” section of the utility cache 213. The file may be opened and used in compilation 214. The process may then return to query 206 as to whether the compilation is complete.

If the query 212 results in a negative response—meaning the pathname is not found on the file system—the pathname may be stored as an entry in a futility section of the cache 225. The process may then return to query 208 as to whether unsearched path directories remain.

Returning to query 210 as to whether a pathname shortcut is in the utility cache, if the answer is yes, then the file may be opened directly via the shortcut to the native file system (NFS) location and used in the compilation 214. The process may then return to query 206 as to whether the compilation is complete.

Returning to query 208 as to whether unsearched path directories remain, if the answer is no, this may mean the compilation has failed, since the compilation is not complete, according to the negative response received to query 206. The process may accordingly exit with an error 215.

We now return to query 209 as to whether the next pathname is in the futility cache. As previously discussed, if the answer is yes, the search for the pathname may be aborted or the pathname may be ignored 219, with the process returning to query 208 to determine if unsearched path directories remain.

Returning now to query 206 as to whether the compilation is complete, if the answer is yes, that is, if the compilation is complete, then version control system (VCS), as discussed below, audit data may be updated via an application programming interface (API) 216, to be provided by the VCS. The process may then return to query 204 as to whether the build is complete.

Continuing with the discussion of query 204, if the build is complete, then collected cache data may be written to the knowledge base 217. As previously discussed, the make wrapper may remove the intermediate cache 218, after which the process may complete 224.

After the build completes, the “make” wrapper, if requested, can store the intermediate cache 106 contents in a specified knowledge base file, as previously mentioned, for use in a subsequent build or for other (e.g., informational) purposes. The knowledge base file can contain a record of both the source files that contributed to the build and the futility data, as well as other information relating to a build.

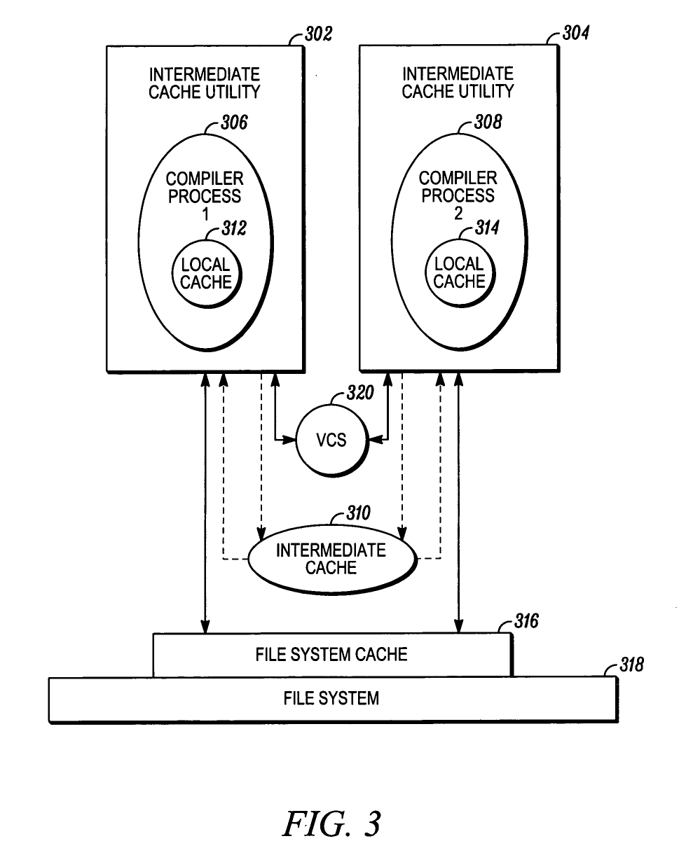

FIG. 3 shows an embodiment of the disclosed intermediate cache utility where parallel build processes can be run on a single system. Accordingly, in a parallel system, different invocations of the immediate cache utilities can mediate interactions between their respective compilers and one or more underlying file systems. Each intermediate cache utility can have a corresponding local intermediate cache in shared memory on the particular build host where the intermediate cache utility is running. The intermediate cache utility can use the local intermediate cache to store futility information along with native file system (NFS) “shortcuts.”

The parallel system of FIG. 3 is shown with two intermediate cache utilities 302 and 304 respectively encompassing compilers, such as compilers 306 and 308, an intermediate cache 310, two local caches 312 and 314, a file system cache 316 and a file system 318. By positioning an intermediate cache 310 between different parallel compiler processes 306 and 308, compilers are allowed to share knowledge about search futility across parallel processes. Local caches 312 and 314 may not necessarily be present and may be provided by the compiler itself.

In another embodiment, were the caches 306 and 308 on the distributed hosts could be synchronized to achieve an additional performance benefit, the intermediate cache utility (or a separate utility) could be enabled to accept synchronization requests from its sibling utilities running on different hosts. When the caches are initially set up, they may be made aware of the other hosts participating in the build. At some defined interval when a sufficient amount of unshared knowledge of futility (and perhaps utility) has been collected, the intermediate cache utility would broadcast its knowledge to its sibling intermediate caches.

As an illustrative example, two compiler processes are shown in FIG. 3. Of course, there may be one or there may be more than two processes executing search and/or open instructions simultaneously, or in sequence. The embodiment of FIG. 3 can include local caches 312 and 314 with the scope of a single compilations on the individual hosts. The local caches 312 and 314 may also include information on the actual location of the source files on the NFS.

The local caches 312 and 314 can map “virtual” file paths to absolute NFS paths. A virtual file system may be defined as any software that mediates between an application and the base file system provided by the operating system. Version-control systems (VCS) can provide virtual file systems. Each “file” in a VCS may be a collection of different versions of the file. The version presented to the user at any given time can be mediated by the VCS. It may be constructed from a stored set of “deltas” that relate a given version to the initial version. It may be a version that is selected with reference to some configuration file. In the method for providing access to the content, there may be overhead associated with the layer of abstraction. This overhead may be avoided during a build by the intermediate “utility” cache. To accomplish this, the intermediate cache can also map “virtual” file paths to the absolute NFS paths. A pathname of a file can also describe the location of a file in a virtual file system.

In another embodiment, a version-control system (VCS) 320 or some other virtual file system layer may be located between the compilers 306 and 308 and the file system 318. In the event that additional overhead is incurred by a VCS 320 or other mediating layer between the compilers 306 and 308 and files in the file system 318 to be accessed, there can be a direct link via the intermediate cache 310 to a file without having to go through the virtual path. In such a situation, having a direct link to the file without having to process the file search through a VCS may provide additional time savings if the same file is accessed more than once during a single compilation. In this manner, the I/O overhead incurred during a build may be reduced.

Additional cache placements and cross-reference between them as well as incorporation of the intermediate cache utility with other utilities are within the scope of the present disclosure. In another embodiment, an application programming interface (API) may be a further enhancement to allow features such as build avoidance and object reuse offered by the underlying virtual file system to continue to be used even when a “utility” cache partition of “shortcuts” may have been employed to map virtual file paths to absolute NFS paths and thus provide shortcuts by caching direct-access paths to content in the native file system. An API may allow the audit information that would have been collected by the VCS by virtue of normal virtual file system accesses to be recorded back to the VCS. The intermediate cache utility can know the virtual files systems (VFS) paths that may have been skipped when using the faster “shortcut” access. The VFS may use an API from the VCS to record this information in the format expected by the VCS's build audit. The API can include as a set of calling conventions which define how a service, here the build auditing facility, is invoked through a software package. The calls, subroutines, interrupts, and returns are included in the documented application programming interface so that a higher-level program like the intermediate cache utility, or its lower-level software components, can employ NFS shortcuts without losing the benefits of build auditing features such as build avoidance and object reuse provided by the VCS.

For a local cache and an intermediate cache, additional random-access memory (RAM) may be provided for the host processing a particular build. The amount of RAM may be determined by the number of source files contributing to the builds, the length of each path name used, the length and number of directory paths to be searched, and the nature of the build distribution across the systems. The intermediate cache utility as described herein may be added to a build environment by wrappering the initial build command and wrappering the compiler itself. Wrappering of the initial build command may include setting up the shared memory for cache use and reading in the contents of a knowledge base file, if supplied. Wrappering of the compiler itself may include providing a suitable version of fopen for tracking failed open system calls and recording NFS shortcuts for successful open system calls and setting up the intermediate cache utility for suitable interaction with a VCS.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the disclosure as determined by the appended claims, as may be amended during the pendency of this application for patent, and all equivalents thereof, when interpreted in accordance with the breadth to which they are fairly, legally and equitably entitled.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

1. A method in a software application for processing files, the method comprising:
attempting to open a file;
searching for the file in a specified plurality of pathnames in a file system; and
storing the pathname of a failed open attempt in a cache when the file is not found in a given pathname of the plurality of pathnames.

2. The method according to claim 1, further comprising:
storing the pathname of a successful open attempt in the cache when the file is found in a second pathname of the plurality of pathnames.

3. The method according to claim 1,
wherein attempting to open a file further comprises querying the cache to determine if the pathname of a failed open attempt is stored in the cache, and
wherein searching does not search the failed pathname in response to determining the pathname of the failed open attempt is stored in the cache as a failed open attempt.

4. The method according to claim 1, further comprising:
querying the cache to determine if a failed open attempt in a specific pathname has occurred; and
ignoring the specific pathname when searching for the file in response to determining a failed open attempt in the specific pathname has occurred.

5. The method according to claim 1 further comprising:
mediating, by the cache, interactions between the software application and the file system.

6. The method according to claim 1 further comprising:
attempting by multiple instantiations of the software application to open a plurality of files; and
mediating interactions by the cache between the multiple instantiations of the software application and the file system.

7. The method according to claim 1 wherein the file system is a native file system, the method further comprising:
mapping, by a local cache, a virtual file system pathname to a native file system pathname.

8. The method according to claim 7 further comprising:
storing in a map cache a map of the virtual file system pathname to the native file system pathname.

9. The method according to claim 1, wherein the software application comprises a compiler.

10. A compiler system, comprising:
a processor;
a file system coupled to the processor;
a compiler coupled to the processor, the compiler configured to open files of the file system, wherein the compiler can futilely attempt to open a file by failing to open the file;
a cache coupled to the processor, the cache configured to store a path of the file for which an attempt to open is futile.

11. The compiler system of claim 10 where the cache is further configured to mediate interactions between the compiler and the file system.

12. The compiler system of claim 10 wherein the compiler is further configured to process a software build and access the cache prior to attempting to open a file during a software build.

13. The compiler system of claim 10, wherein the compiler can successfully attempt to open a file, and wherein the cache is further configured to store the path of the file as a successful path when an attempt to open the file is successful.

14. The compiler system of claim 13, wherein the compiler is configured to process a software build, the cache is configured to store the paths of all files for which attempts to open are futile, for a particular software build, and the cache is further configured to store the paths of all files for which attempts to open are successful, for a particular software build.

15. The compiler system of claim 10 further comprising:
multiple instantiations of the compiler; and
shared memory configured so that each of the multiple instantiations has access to the cache.

16. The compiler system of claim 15, wherein the cache is configured to mediate interactions between the multiple instantiations and the file system.

17. The compiler system of claim 10 wherein the file system is a native file system, and wherein the compiler system further comprises a local cache configured to map a virtual file system path to a native file system path.

18. The compiler system of claim 17 further comprising:
a map cache configured to store a map of the virtual file path to the native file system path.

19. The compiler system of claim 17 further comprising an application programming interface to enable the recording of contributing source files in the format defined by a virtual file system that supports build auditing for the purposes of build avoidance and object reuse.

20. A method of a compiler, comprising:
setting up a cache;
searching for files of a file system; and
storing paths of futile searches of files in the cache.

21. The method according to claim 20, further comprising:
mediating by the cache interactions between the compiler and the file system.

22. The method according to claim 20, further comprising:
attempting by multiple instantiations of the compiler to open the files; and
mediating interactions by the cache between the multiple instantiations of the compiler and the file system.

23. A method in a software process acting on a plurality of files, wherein the software process makes a plurality of attempts to open a plurality of files, the method comprising:
tracking, in a cache, the pathnames of files the software process attempted to open and failed; and
omitting an attempt to open a file where a pathname of the file has been tracked in the cache due to a failure on a previous attempt to open the file.

24. The method of claim 23, further comprising:
tracking, in the cache, the pathnames of files the software process attempted to open and succeeded.

25. The method of claim 23, wherein the software process comprises a plurality of instantiations, the method further comprising:
configuring shared memory so that each of the instantiations has access to the cache.

26. The method of claim 23, wherein a pathname of the file describes the location of the file in a virtual file system.
